(19) United States
(12) Patent Application Publication
(10) Pub. No.: US 2026/0264778 A1
(43) Pub. Date: Sep. 10, 2026

(54) TRACK ASSEMBLIES FOR TRACK DRIVEN VEHICLES

(71) Applicant: Caterpillar Inc., Peoria, IL (US)

(72) Inventors: Arthur BLAND, Chillicothe, IL (US); Li ZHANG, Dunlap, IL (US); Yaodong ZHOU, Hedong District, Tianjin (CN)

(73) Assignee: Caterpillar Inc., Peoria, IL (US)

(21) Appl. No.: 19/074,877

(22) Filed: Mar. 10, 2025

(51) Int. Cl. B62D 55/20; B62D 55/125; B62D 55/14; B62D 55/28

(52) U.S. Cl. CPC B62D 55/20; B62D 55/125; B62D 55/14; B62D 55/28

(57) ABSTRACT

A track link for a chain assembly of a mobile machine, including: a first track link configured to be connected a plurality of other track links, the first track link including: a link body including a top surface and a bottom surface, and a cavity formed in an interior of the link body and extending to the bottom surface, a sensing device installed within the cavity of the link body; and a track shoe installed on the bottom surface of the link body, where the track shoe covers the cavity in the link body.

### TECHNICAL FIELD

The present disclosure relates generally to track assemblies including track links for track driven vehicles, and, more specifically, the disclosure relates to track assemblies including sensors that measure wear of the track links.

### BACKGROUND

Track-type mobile machines include track driven vehicles, which utilize track chains on each side of the machine that engage the ground surface during propulsion of the machine. A plurality of individual track links are pivotably coupled to one another via bushing and pin arrangements, referred to as track pin assemblies, to form the continuous or endless track chain. A sprocket, driven by an engine of the machine, engages the track pin assemblies and translates the chain about one or more idlers. As the track chain translates, the connected track links engage the ground surface under the machine, for example, via track shoes that are coupled to the track chain, which propels the machine on the ground surface. The track chains can be straight link chains with alternating inner and outer links, or can be offset link chains where all the links are alike. The track shoes are typically connected to the track links by a bolt-and-nut arrangement. The mobile machines operate under harsh conditions, and thus the components of the track chain, including the track links, are subject to wear.

U.S. Patent Publication No. 2022/0185399 to Grenzi (“the '399 publication”) is directed to a heavy-duty vehicle including a crawler track. The track may include a sensor, which may be configured to detect a physical quality of the crawler track or of the vehicle. However, because the '399 publication shows that portions of the sensors are exposed, including side surfaces of the sensors, and thus the sensors are liable to suffer damage due to impacts from rocks or other materials on a work site. The '399 publication is further concerned with enclosing the power sources for the sensors (i.e., the rectennas).

Accordingly, systems and methods of the present disclosure may address or solve one or more problems in the art. The scope of the current disclosure, however, is defined by the attached claims, and not by the ability to solve any specific problem.

### SUMMARY OF THE INVENTION

In some aspects, a track link for a chain assembly of a mobile machine comprises: a first track link configured to be connected a plurality of other track links, the first track link comprising: a link body including a top surface and a bottom surface, and a cavity formed in an interior of the link body and extending to the bottom surface, a sensing device installed within the cavity of the link body; and a track shoe installed on the bottom surface of the link body, wherein the track shoe covers the cavity in the link body.

In some aspects, a mobile machine comprises: a frame; a driving mechanism coupled to the frame and configured to generate a torque output; a drive sprocket coupled to the driving mechanism; and a chain assembly configured to be driven by the drive sprocket, to propel the mobile machine across a ground surface, the chain assembly comprising: a plurality of track links configured to be connected to one another to form the chain assembly, the plurality of track links including a first track link comprising: a link body including a top surface and a bottom surface opposite the top surface, and a cavity formed in an interior of the link body and extending to the bottom surface, a sensing device installed within the cavity of the link body, wherein the sensing device is configured to sense a wear parameter indicative of an amount of wear of the top surface of the link body, and to transmit the wear parameter; and a track shoe installed on the bottom surface of the link body, wherein the track shoe covers the cavity in the link body.

In some aspects, a mobile machine includes: a driving mechanism configured to generate a torque output; a drive sprocket coupled to the driving mechanism; a roller frame; at least one roller coupled to the roller frame; at least one idler coupled to the roller frame; and a chain assembly configured to be driven by the drive sprocket, to propel the mobile machine across a ground surface, the chain assembly comprising: a plurality of track links configured to be connected to one another to form the chain assembly, the plurality of track links including a first track link comprising: a link body including a top surface and a bottom surface opposite the top surface, and a cavity formed in an interior of the link body and extending to the bottom surface, a sensing device installed within the cavity of the link body, wherein the sensing device is configured to sense a wear parameter indicative of an amount of wear of the top surface of the link body caused by at least one of the at least one roller, the at least one idler, or the drive sprocket, wherein the sensing device is configured to transmit the wear parameter; and a track shoe installed on the bottom surface of the link body, wherein the track shoe covers the cavity in the link body; and a controller configured to receive the wear parameter from the sensing device.

### BRIEF DESCRIPTION OF THE DRAWINGS

The accompanying drawings, which are incorporated in and constitute a part of this specification, illustrate various aspects of the disclosure, and, together with the description, serve to explain aspects of the disclosure.

FIG. 1 illustrates a side view of an exemplary machine in the form of a track driven vehicle, according to aspects of the disclosure

FIG. 2 illustrates a top isometric view of a track link of the track driven vehicle of FIG. 1, according to aspects of the disclosure.

FIG. 3 illustrates a partial bottom isometric view of the track link of FIG. 2, according to aspects of the disclosure.

FIG. 4 illustrates a partial cross-section view of the track link of FIGS. 2 and 3, with a track shoe installed thereon, according to aspects of the disclosure.

### DETAILED DESCRIPTION

Both the foregoing general description and the following detailed description are exemplary and explanatory only and do not restrict the claims. The terms “comprises,” “comprising,” “having,” “including,” or other variations thereof, used herein cover a non-exclusive inclusion such that a process, method, article, or apparatus that comprises a list of elements does not include only those elements, but may include other elements not expressly listed or inherent to such a process, method, article, or apparatus. Further, relative terms, such as, for example, “about,” “substantially,” “generally,” “approximately,” or other variations thereof, include a possible variation of ±10% in a stated value, unless stated otherwise. Still further, the terms “one or more,” “at least one,” and variations thereof, include one, two, or more than two (e.g., a plurality). Additionally, terms such as “top” and “bottom” are exemplary only and may refer to an orientation of a component in a particular figure, for example, and do not require that the component is oriented such that a “top” is above a “bottom.”

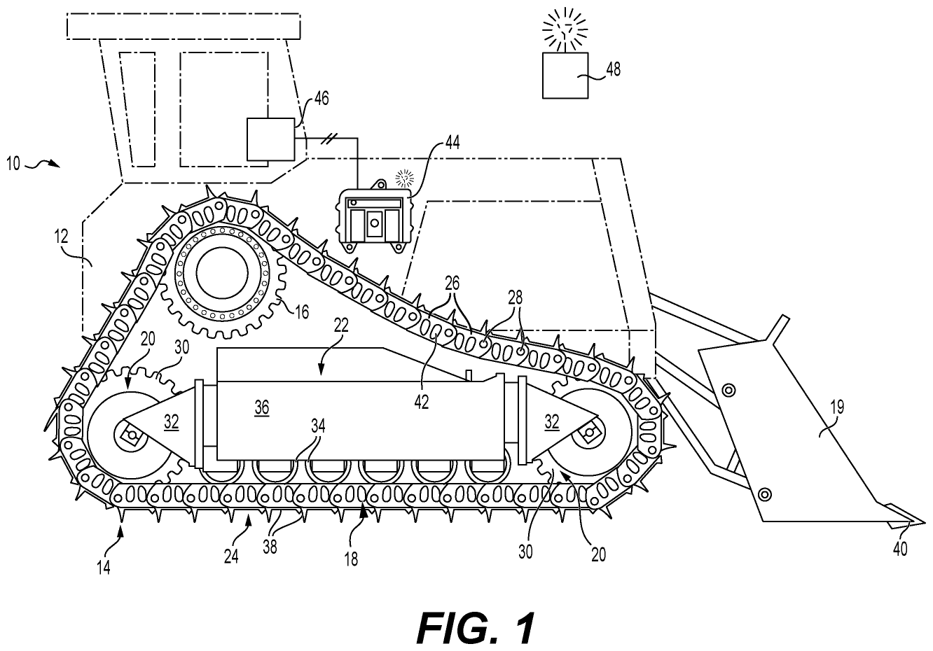

FIG. 1 illustrates an exemplary machine 10, according to aspects of the disclosure. The machine 10, which may be a mobile machine in the form of a track driven vehicle, may embody any machine that is driven, propelled, positioned, or maneuvered by operating a continuous or endless track-type traction device. These machines may include, for example, track-type tractors, skid steers, dozers, excavators, backhoes, track loaders, front shovels, rope shovels, or any other type of track-maneuverable machine. The machine 10 may include a frame 12 and a pair of track assemblies 14 (only one shown) secured to the frame 12 on opposite sides of the machine 10. As FIG. 1 shows, the track assembly 14 may include a drive sprocket 16 coupled to a driving mechanism (not shown), as well as a chain assembly 18 operatively coupled to the driving mechanism by the drive sprocket 16 and configured to propel the machine 10 on the ground surface. The machine 10 may also include a work tool 19, which may be attached at a front end of the machine 10.

The driving mechanism may include one or more components configured to generate a torque output, to drive the machine 10 on the ground surface. For example, the driving mechanism may include any suitable type of internal combustion engine, such as a gasoline, diesel, natural gas, propane, or hybrid-powered engine or turbine. Alternatively or additionally, the driving mechanism may embody an electric motor, electrically coupled to an electric power source and configured to convert at least a portion of the electrical energy from the electric power output into mechanical energy. According to yet another example, the driving mechanism may include a hydraulic motor fluidly coupled to a hydraulic pump and configured to convert a fluid pressurized by the pump into a torque output.

The drive sprocket 16 may be coupled to the driving mechanism via a shaft, which may provide an interface for delivering torque generated by the driving mechanism to the drive sprocket 16. For example, the drive sprocket 16 may be secured (e.g., welded, bolted, heat-coupled, etc.) to a hub associated with a shaft, so that the drive sprocket 16 rotates in response to the torque generated by the driving mechanism. In some aspects of the disclosure, the drive sprocket 16 may be directly coupled via a drive shaft to the driving mechanism. In other aspects of the disclosure, the drive sprocket 16 may be coupled to the driving mechanism via a torque converter (such as a gearbox, transmission, etc.), so that rotation of the drive sprocket 16 is proportional to the torque generated by the driving mechanism.

The track assembly 14 may include a plurality of components that form a continuous or endless track, which is the ground-engaging portion of the drive system of the machine 10. The track assembly 14 may include, among other components, the drive sprocket 16, the chain assembly 18, at least one idler assembly 20, a roller assembly 22, and a traction assembly 24. However, these components of the track assembly 14 are exemplary only and not intended to be limiting. Accordingly, the track assembly 14 may include additional or components other than those discussed or illustrated.

The chain assembly 18 may form a continuous or endless chain connected around outer portions of the drive sprocket 16, the idler assemblies 20, and the roller assembly 22. The traction assembly 24 may be connected to an outer portion of the chain assembly 18 and configured to engage the ground surface beneath the machine 10. During operation of the machine 10, rotation of the drive sprocket 16 may cause the chain assembly 18 to move around the drive sprocket 16, the idler assemblies 20, and the roller assembly 22, causing the traction assembly 24 to engage the ground surface and thereby propel the machine 10.

In some aspects of the disclosure, the chain assembly 18 may include a plurality of track links 26 that are interconnected with one another. The term “track link,” as used herein, refers to any linkage component of a continuous or endless chain for a track-type machine, and is not limited to track links 26 described herein. Adjacent (e.g., consecutive) track links 26 may be coupled to one another via a plurality of track pin assemblies 28. In some aspects of the disclosure, each of the two (2) chain assemblies 18 on opposite side of the machine 10 may include two parallel sets of track links 26, connected to each other by the track pin assemblies 28.

The idler assemblies 20 may include components configured to guide the chain assembly 18 as the chain assembly 18 moves around components of the track assembly 14. For example, each of the idler assemblies 20 may include an idler 30 and a mount 32. The idlers 30 may include features configured to engage the chain assembly 18. The idlers 30 may include engagement surfaces configured to contact and guide the track links 26 as the track links 26 pass around the idler 30. As FIG. 1 illustrates, the idler 30 may include idler teeth (e.g., between the engagement surfaces) that are configured to engage the track pin assemblies 28. Mounts 32 may hold each of the idlers 30 in place on the machine 10 through connections to the frame 12.

The roller assembly 22 may also include components that are configured to guide the chain assembly 18. For example, the roller assembly 22 may include a plurality of rollers 34 and a roller frame 36. The roller frame 36 may be mounted to the frame 12 of the machine 10. The rollers 34 may guide the chain assembly 18 at a lower side of the roller frame 36 (e.g., a side closer to the ground surface). The rollers 34 may each be suspended from the roller frame 36. For example, each of the rollers 34 may be rotationally supported on an axle suspended below the roller frame 36. The rollers 34 may ride on and guide the track links 26 as the track links 26 pass under the roller frame 36. In accordance with some aspects of the disclosure, the track assembly 14 may also include one or more carrier rollers (not shown), which are configured to support a portion of chain assembly 18.

As FIG. 1 illustrates, the traction assembly 24 may include a plurality of track shoes 38 carried by the chain assembly 18. The track shoes 38 may be removably connected to the chain assembly 18, each of the track shoes 38 including a connecting portion that is configured to be secured to one or more of the track links 26, as well as a ground-engaging portion that is configured to contact the ground surface. The ground-engaging portion of the track shoes 38 may include one or more features (e.g., grouser bars) that provide increased traction between the track shoes 38 and the ground surface. However, aspects of the disclosure may be used with any type of track shoe forming a part of a track assembly used by a track-type mobile machine.

The work tool 19 may include any device used to perform a particular task on a worksite as the machine 10 moves across the ground surface. For example, the work tool 19 may include a bucket, a plow, a blade, or another task-performing device. The work tool 19 may include a ground-engaging member 40, such as an edge protector, tooth member, etc. The ground-engaging member 40 may be configured to contact the ground surface (or other working material) during performance of a task, and may be replaceable, such as when the ground-engaging member 40 is worn.

In an aspect of the disclosure, the machine 10 may include one or more components of a detection system that is configured to monitor one or more parameters of the track assembly 14. For example, as FIG. 1 shows, the machine 10 may include at least one sensing device 42 and a controller 44. The sensing device 42 may be an electronic device (e.g., a sensor) configured to detect one or more parameters associated with use of the machine 10, and to transmit a signal indicative of the one or more parameters, such as to the controller 44. The controller 44 may be configured to transmit information received from the sensing device 42, such as the one or more parameters or other information, to another device, such as an on-board computer 46 or off-board computer 48. The on-board computer 46 may be located, installed, or otherwise on the machine 10, while the off-board computer 48 may be located off of or remote from the machine 10. Accordingly, information associated with the one or more parameters of the machine 10 may be automatically determined (e.g., by the sensing device 42) and transmitted (e.g., by the sensing device 42 or the controller 44) to the desired destination (e.g., the on-board computer 46 or the off-board computer 48, for display to an operator, supervisor, or other system).

In accordance with some aspects of the disclosure, the detection system may be configured to monitor a wear parameter. For example, the sensing device 42 may be configured to measure one or more parameters associated with an amount of wear experienced by a component of the machine 10, and transmit a signal indicative of the amount of wear, based on or corresponding to the wear parameter, to the controller 44. As used herein, a “wear parameter” is a measurement or other characteristic of a monitored component or of the sensing device 42 which may indicate an amount of wear experienced by the monitored component (when compared to a previous measurement or other previous characteristic, for example) or an amount of expected life remaining. In an example, the sensing device 42 may be installed within the track link 26 and may be configured to detect a wear parameter of a surface of the track link 26, as further described.

The controller 44 may include one or more computing devices, such as a one or more microprocessors. For example, the controller 44 may embody a general microprocessor capable of controlling numerous functions of the machine 10, including wear monitoring. The controller 44 may also include one, some, or all of the components required to run an application such as, for example, a computer-readable memory, a secondary storage device, and a processor, such as a central processing unit. Various other known circuits may be associated with the controller 44, including a power source and other appropriate circuitry. Further, the controller 44 may include communication hardware or software configured to perform one or more processes to allow the controller 44 to communicate (e.g., wirelessly or through a wired connection) with the sensing device 42 and at least one of the on-board computer 46 or the off-board computer 48.

As stated, the on-board computer 46 may be a computing device located within or on the machine 10 (e.g., inside an operator cabin of the machine 10). For example, the on-board computer 46 may be a dashboard computer, and may include at least a processor and a display. The on-board computer 46 may communicate with the controller 44 (e.g., via a wired or wireless connection) to receive wear parameter information. The on-board computer 46 may display wear parameter information or information derived from wear parameter information, such as to an operator or occupant of the machine 10.

The off-board computer 48 may be a similar or different computing device, which is located away from the machine 10 (e.g., not within or on the machine 10, such as inside a building). The off-board computer 48 may include at least a processor and a display. The off-board computer 48 may be configured to communicate with the controller 44 or the on-board computer 46 (e.g., via a wireless network) to receive wear parameter information or information derived from wear parameter information, which may be displayed to a person, such as a supervisor supervising the operator of the machine 10, or a remote operator of the machine 10, or a system located remotely from the machine 10.

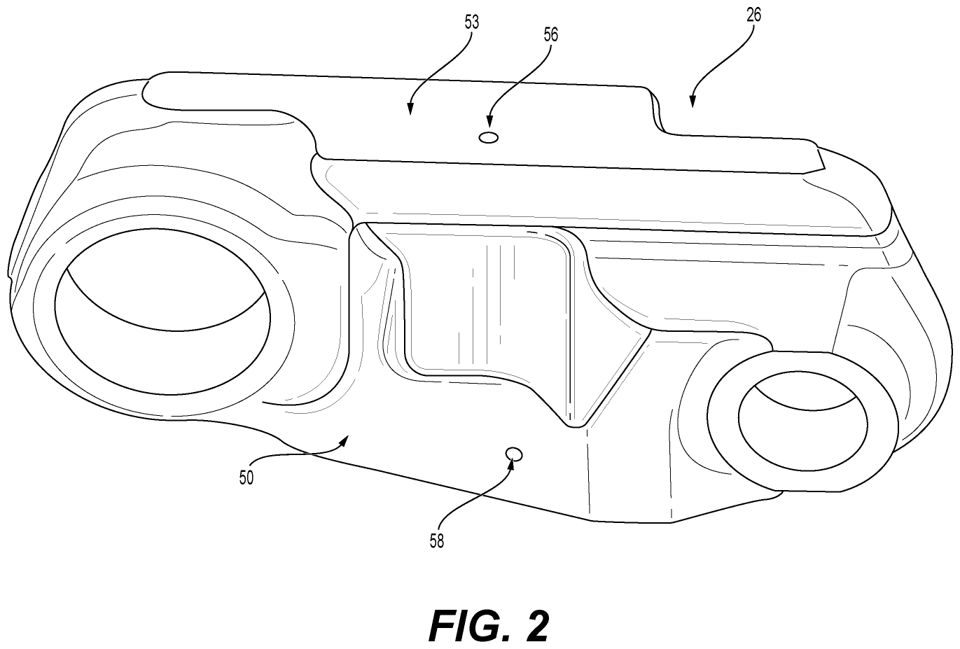

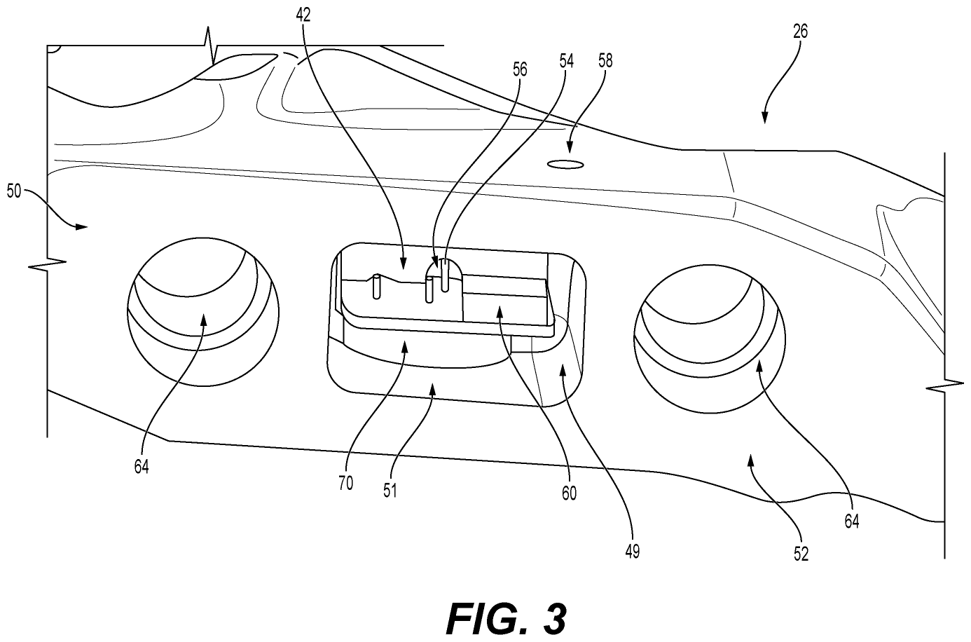

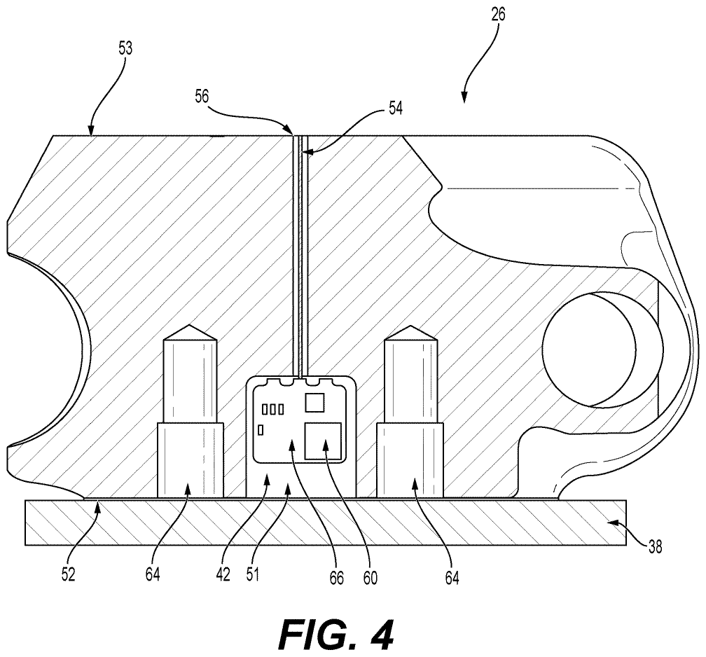

FIGS. 2 and 3 illustrate a top isometric view and a partial bottom isometric view of the track link 26 including the sensing device 42 installed therein, respectively, and FIG. 4 illustrates a partial cross-section view of the track link 26 including the sensing device 42 with the track shoe 38 installed on the track link 26, in accordance with aspects of the disclosure. As stated, the sensing device 42 may be configured to transmit a signal, data, or other information indicative of the wear parameter to the controller 44. For example, the controller 44 may be configured to receive the signal from the sensing device 42, and perform one or more processes to detect wear of the track link 26, such as by comparing the wear parameter to stored information or transmitting a corresponding signal to the on-board computer 46 or the off-board computer 48.

As FIGS. 2-4 illustrate, the track link 26 may include a link body 50 including a bottom surface 52, and a top surface 53 opposite the bottom surface 52. In some aspects, the top surface 53 or the bottom surface 52 are substantially flat or planar surfaces, which may or may not extend substantially parallel to one another. The link body 50 may include a cavity 51 formed in its interior, and the cavity may extend to the bottom surface 52 of the link body 50 (e.g., the cavity may be open to the bottom surface 52). The sensing device 42 may be installed or disposed within the cavity 51 of the track link 26, such that the sensing device 42 may be configured to measure a wear parameter associated with the top surface 53 of the link body 50. As the figures illustrate, the top surface 53 may be an engagement surface of the track link 26, which is configured to contact other components of the track assembly 14 (e.g., the rollers 34) as the chain assembly 18 moves the machine 10 across the ground surface. A volume between the sensing device 42 and walls of the cavity 51 (e.g., an interior of the cavity 51) may be filled with a potting material (e.g., a resin) to fill and seal the cavity 51 and to protect the sensing device 42 from damage.

The link body 50 may include a channel 56 extending from the cavity 51 to the top surface 53. The sensing device 42 may include a tail 54 that is configured to measure the wear parameter of the top surface 53. The sensing device 42 may be disposed in the cavity 51 such that the tail 54 extends through the channel 56, and an end of the tail 54 is disposed near or at the top surface 53 of the link body 50. In some arrangements, the end of the tail 54 may be coplanar with the top surface 53. Accordingly, the end of the tail 54 and the top surface 53 may wear substantially together. The sensing device 42 may sense the wear of the tail 54, which is indicative of the wear of the top surface 53 of the link body 50. In this way, the sensing device 42 may measure a wear parameter of the tail 54, which may be representative of an amount of wear experienced by the track link 26, such as the top surface 53 of the link body 50. In some examples, the tail 54 is a relatively soft tail, for example a wire or other generally flexible component. In some other examples, the tail 54 is a relatively hard tail, such as a rod or generally inflexible component. In some aspects of the disclosure, a potting material may fill a volume between the tail 54 and an interior wall of the channel 56, such that the potting material prevents dirt and debris from filling the channel 56 when the track link 26 is installed on the machine 10 operating on a work site. Although the figures illustrate the channel 56 as having a circular cross-section, the channel 56 is not limited to this cross-sectional shape. In some aspects of the disclosure, the sensing device 42 is an ultrasonic sensor, and does not include a tail. Accordingly, in some aspects of the disclosure, the link body 50 does not include the channel 56.

The link body 50 may include a channel 58 extending from the cavity 51 to a side surface of the link body 50. The sensing device 42 may include an antenna 60, which is configured to transmit information, including the wear information, wirelessly, to at least one of the controller 44, the on-board computer 46, or the off-board computer 48. In some aspects of the disclosure, the antenna 60 may transmit via Bluetooth®. The sensing device 42 may be disposed in the cavity 51 such that the antenna 60 is substantially aligned with the channel 58, and thus the link body 50, which may be formed from a metal material, does not block the transmission of the wear parameter information by the sensing device 42. In some aspects of the disclosure, the channel 58 may be filled with a potting material, such that the potting material prevents dirt and debris from filling the channel 58. Although the figures illustrate the channel 58 as having a circular cross-section, the channel 58 is not limited to this cross-sectional shape. In some aspects of the disclosure, a diameter of the channel 58 is about 10 mm, 13 mm, 15 mm, or 16 mm.

As shown in FIGS. 2-4, the track link 26 may include a pair of bores 64, which are holes that may be threaded or which may include threaded nuts disposed therein. The bores 64 may be configured to receive ends of mechanical fasteners (e.g., bolts), such that the bolts may fasten the track link 26 to another component, such as the track shoe 38. As FIG. 4 illustrates, when the sensing device 42 is installed within the cavity 51 of the track link 26, and the track shoe 38 is installed on the track link 26, the cavity 51 is closed, and the sensing device 42 is completely surrounded or enclosed by the structure of the link body 50 and the track shoe 38.

As FIGS. 3 and 4 illustrate, the sensing device 42 may further include a circuit board 66 and a power source 70. The tail 54 may be electrically connected to the circuit board 66. The circuit board 66 may be configured to generate, receive, transmit, or modify a signal indicative of the wear parameter. In some aspects of the disclosure, the circuit board 66 may include a signal conditioner, an amplifier, a multiplexer, or a converter (e.g., an analog-to-digital (A/D) converter or a digital-to-analog (D/A) converter). In accordance with some aspects of the disclosure, the circuit board 66 may include a controller, such as a low-power microcontroller, that may provide an output in response to the input received from the tail 54 or one or more signals processed by any or all of the other components circuit board 66. The circuit board 66 may further include a memory device, such as either or both of a random-access memory (RAM) or a read-only memory (ROM), which may store information related to operation of the sensing device 42, and information related to the wear parameter. Alternatively or additionally, the memory device may store instructions used by one or more other components of the sensing device 42, such as the circuit board 66.

The power source 70 may supply power to one or more of the components of the sensing device 42, including the circuit board 66, the tail 54, or components associated with the antenna 60. In some aspects of the disclosure, the power source 70 may include a battery, such as a coin-cell type battery. In some examples, the power source 70 may additionally or alternatively include a motion-based energy source, such as a vibration-based energy-harvesting system, to power one or more of the components of the sensing device 42, or may be used to charge a battery of the power source 70. In yet another example, the power source 70 may include a battery configured to be wirelessly charged (e.g., via near field charging), such as when the sensing device 42 is disposed within the link body 50.

### Industrial Applicability

The disclosed track links 26 may be used in the track assemblies 14 of machines 10, including mobile machines in the form of track driven vehicle, to sense the wear of one or more components of the track assemblies 14. For example, as discussed, one or more of the track links 26 may include the sensing devices 42 installed in the cavities 51 of the link bodies 50. The sensing devices 42 may be configured to measure wear parameters of the track assemblies 14, including wear of the top surfaces 53 of the link bodies 50.

As the figures illustrate and the disclosure describes, the sensing device 42 may be installed within the cavity 51, such that the sensing device 42 is completely surrounded by the link body 50 and the track shoe 38. As a result, the sensing device 42 is protected from damage, which might otherwise be result from dirt, rocks, or other debris impacting the sensing device 42, as the machine with the track link 26 including the sensing device 42 moves across the ground surface of the work site.

The channel 56 within the link body 50 allows the tail 54 of the sensing device 42 to measure the wear parameter, while the sensing device 42 remains isolated in the cavity 51. The use of a potting material in the channel 56 prevents dirt and debris from entering the channel 56 or the cavity 51, and protects the tail 54, while maintaining the position of the tail 54. Additionally, the channel 58 within the link body allows the antenna 60 to transmit the wear parameter information, while the sensing device 42 remains isolated in the cavity 51. Alignment of the antenna 60 with the channel 68 allows the wireless signal to be transmitted by the sensing device 42 unimpeded by structure of the link body 50. The use of a potting material in the channel 58 prevents dirt and debris from entering the channel 58 or the cavity 51, without impeding wireless transmission of the wear parameter information. As a result, the sensing device 42 accurately measures the wear parameter of the track link 26, while the lifetime of the sensing device 42 is increased. For example, the potting material and the sensing device 42 are isolated within the link body 50, and as a result both the potting material and the sensing device 42 are protected from impacts. As a result, less loads are applied to the sensing device 42.

It will be apparent to those skilled in the art that various modifications and variations may be made to the disclosed system without departing from the scope of the disclosure. Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A track link for a chain assembly of a mobile machine, comprising:
a first track link configured to be connected a plurality of other track links, the first track link comprising:
a link body including a top surface and a bottom surface, and
a cavity formed in an interior of the link body and extending to the bottom surface,
a sensing device installed within the cavity of the link body; and
a track shoe installed on the bottom surface of the link body, wherein the track shoe covers the cavity in the link body.

2. The track link of claim 1, wherein the sensing device comprises a tail configured to determine an amount of wear on a surface of the link body,
wherein the link body further comprises a channel extending from the cavity to the top surface of the link body,
wherein the tail extends through the channel to a location at or near the top surface.

3. The track link of claim 1, wherein the sensing device comprises an antenna,
wherein the link body further comprises a channel extending from the cavity to a side surface of the link body,
wherein the antenna of the sensing device is aligned with the channel.

4. The track link of claim 1, wherein the sensing device comprises a tail configured to determine an amount of wear on a surface of the link body, and an antenna,
wherein the link body further comprises a first channel extending from the cavity to the top surface of the link body, and a second channel extending from the cavity to a side surface of the link body,
wherein the tail extends through the first channel to a location at or near the top surface,
wherein the antenna of the sensing device is aligned with the second channel.

5. The track link of claim 1, wherein the sensing device comprises circuit board, a tail connected to the circuit board, an antenna connected to the circuit board, and a power source configured to supply power to the circuit board,
wherein the link body further comprises a first channel extending from the cavity to the top surface of the link body, and a second channel extending from the cavity to a side surface of the link body,
wherein the tail extends through the first channel to a location at or near the top surface,
wherein the antenna of the sensing device is aligned with the second channel,
wherein a potting material is disposed within at least one of the cavity, the first channel, or the second channel.

6. The track link of claim 1, wherein the link body and the track shoe completely surround the sensing device.

7. The track link of claim 1, further comprising bolts,
wherein the link body further comprises bores,
wherein each of the bolts extend through a respective hole in the track shoe and one of the bores of the link body, to install the track shoe on the first track link.

8. The track link of claim 1, wherein the sensing device comprises a tail configured to determine an amount of wear on a surface of the link body,
wherein the tail comprises a wire.

9. The track link of claim 1, wherein the sensing device comprises a tail configured to determine an amount of wear on a surface of the link body,
wherein the tail comprises a rod.

10. A mobile machine, comprising:
a frame;
a driving mechanism coupled to the frame and configured to generate a torque output;
a drive sprocket coupled to the driving mechanism; and
a chain assembly configured to be driven by the drive sprocket, to propel the mobile machine across a ground surface, the chain assembly comprising:
a plurality of track links configured to be connected to one another to form the chain assembly, the plurality of track links including a first track link comprising:
a link body including a top surface and a bottom surface opposite the top surface, and
a cavity formed in an interior of the link body and extending to the bottom surface,
a sensing device installed within the cavity of the link body, wherein the sensing device is configured to sense a wear parameter indicative of an amount of wear of the top surface of the link body, and to transmit the wear parameter; and
a track shoe installed on the bottom surface of the link body, wherein the track shoe covers the cavity in the link body.

11. The mobile machine of claim 10, wherein the sensing device comprises a tail configured to determine the amount of wear on the top surface of the link body,
wherein the link body further comprises a channel extending from the cavity to the top surface of the link body,
wherein the tail extends through the channel to a location at or near the top surface.

12. The mobile machine of claim 10, wherein the sensing device comprises an antenna configured to transmit the wear parameter,
wherein the link body further comprises a channel extending from the cavity to a side surface of the link body,
wherein the antenna of the sensing device is aligned with the channel.

13. The mobile machine of claim 10, wherein the sensing device comprises a tail and an antenna, wherein the tail is configured to determine the amount of wear on the top surface of the link body, wherein the antenna is configured to transmit the wear parameter,
wherein the link body further comprises a first channel extending from the cavity to the top surface of the link body, wherein the tail extends through the first channel to a location at or near the top surface,
wherein the link body further comprises a second channel, wherein the antenna is aligned with the second channel.

14. The mobile machine of claim 13, further comprising a potting material disposed within at least one of the cavity, the first channel, or the second channel.

15. The mobile machine of claim 10, wherein the link body and the track shoe completely surround the sensing device.

16. The mobile machine of claim 10, further comprising:
a controller configured to receive the wear parameter transmitted from the sensing device, and to provide an output based on the wear parameter, and
a computer configured to display the output received from the controller.

17. A mobile machine, comprising:
a driving mechanism configured to generate a torque output;
a drive sprocket coupled to the driving mechanism;
a roller frame;
at least one roller coupled to the roller frame;
at least one idler coupled to the roller frame; and
a chain assembly configured to be driven by the drive sprocket, to propel the mobile machine across a ground surface, the chain assembly comprising:
a plurality of track links configured to be connected to one another to form the chain assembly, the plurality of track links including a first track link comprising:
a link body including a top surface and a bottom surface opposite the top surface, and
a cavity formed in an interior of the link body and extending to the bottom surface,
a sensing device installed within the cavity of the link body, wherein the sensing device is configured to sense a wear parameter indicative of an amount of wear of the top surface of the link body caused by at least one of the at least one roller, the at least one idler, or the drive sprocket, wherein the sensing device is configured to transmit the wear parameter; and
a track shoe installed on the bottom surface of the link body, wherein the track shoe covers the cavity in the link body; and
a controller configured to receive the wear parameter from the sensing device.

18. The mobile machine of claim 17, wherein the controller is configured to transmit an output corresponding to the wear parameter to an off-board computer.

19. The mobile machine of claim 17, wherein the sensing device comprises a tail and an antenna, wherein the tail is configured to determine the amount of wear on the top surface of the link body, wherein the antenna is configured to transmit the wear parameter,
wherein the link body further comprises a first channel extending from the cavity to the top surface of the link body, wherein the tail extends through the first channel to a location at or near the top surface,
wherein the link body further comprises a second channel extending from the cavity to a side surface of the link body, wherein the antenna is aligned with the second channel.

20. The mobile machine of claim 19, further comprising a potting material disposed in each of the cavity, the first channel, and the second channel.
